(19) United States
(12) Patent Application Publication
(10) Pub. No.: US 2004/0159488 A1
(43) Pub. Date: Aug. 19, 2004

(54) Torque sensor and motor-driven power steering apparatus using thereof

(75) Inventors: Masahiro Matsumoto, Hitachi-shi (JP); Masamichi Yamada, Hitachinaka-shi (JP)

Correspondence Address: CROWELL & MORING LLP, INTELLECTUAL PROPERTY GROUP, P.O. BOX 14300, WASHINGTON, DC, 20044-4300, US

(73) Assignee: Hitachi, Ltd., Chiyoda-ku (JP)

(21) Appl. No.: 10/776,257

(22) Filed: Feb. 12, 2004

Related U.S. Application Data
(63) Continuation of application No. 10/373,661, filed on Feb. 26, 2003.

(30) Foreign Application Priority Data
Jul. 25, 2002 (JP) 2002-216165

(51) Int. Cl. B62D 5/04

(52) U.S. Cl. 180/443

(57) ABSTRACT

A torque sensor includes input and output axes coupled through a torsion bar, magnetic media attached to the input and output axes and having magnetic tracks magnetized at a predetermined pitch and magnetic detection elements disposed opposite to the magnetic media to be sensitive to the magnetic tracks. At least two magnetic tracks for detection of torque are formed with a magnetic phase difference in each of the magnetic media attached to the input and output axes.

### BACKGROUND OF THE INVENTION

The present invention relates to a torque sensor for detecting torque exerted on an input axis (first axis) and an output axis (second axis) coupled through a torsion bar and more particularly to a torque sensor suitable for detection of steering torque in power steering, for example.

Heretofore, as torque sensors of this kind, JP-A-3-204374 discloses an apparatus which utilizes a magnetic encoder system to detect the torque exerted on an input axis (first axis) and an output axis (second axis) and JP-A-2001-324394 discloses a torque detecting apparatus which includes magnetic projections disposed on input and output axes and detects the torque exerted on the input and output axes by utilizing an output difference of magnetic sensors responsive to the magnetic projections. These torque detecting apparatuses are to detect the torque exerted on the input and output axes on the basis of a torsional angle produced in a torsion bar.

The principle of the torque detection using the conventional magnetic encoder system disclosed in JP-A-3-204374 and the like is now described with reference to FIGS. 2 to 4.

In the torque detecting apparatus of this kind, two rotational axes are coupled by means of a torsion bar so that torsion is produced in the torsion bar by the torque exerted on the two rotational axes. The torsional angle of the torsion bar can be obtained by detecting magnetic signals recorded on magnetic drums 25 (magnetic medium) supported by the rotational axes and the torque can be calculated on the basis of the torsional angle.

As shown in FIG. 2, the outer peripheries of the magnetic drums 25 are repeatedly magnetized with N and S poles at a magnetization pitch λ. FIG. 2 shows only one of the two magnetic drums. A substrate 22 is disposed opposite to the magnetic drums 25 and MR elements (magneto-resistive element) 23 and 24 are disposed in the substrate 22 with the space of λ/4 therebetween. When torque is exerted on the two rotational axes (input and output axes), the two rotational axes are rotated, so that torsion (difference in rotational angles of the rotational axes) is produced in the torsion bar coupling the two rotational axes in accordance with the magnitude of the torque produced at this time.

As shown in FIG. 3, an output of the MR element 23 is changed like the sine wave in accordance with the rotational angle. Further, an output of the MR element 24 is also changed like the sine wave with a phase difference of 90 degrees (λ/4) with respect to the output of the MR element 23. The rotational angles of the respective magnetic drums 25 can be obtained by calculating the arc tangent of the output signals of the MR elements 23 and 24. Moreover, a difference between the respective rotational angles is calculated to thereby obtain a torsion amount of the torsion bar, so that the torque is calculated from the torsion amount.

In the case of such a torque sensor, the magnetization pitch λ of the magnetic drum must be made larger than the maximum of the torsional angle of the torsion bar. Accordingly, the magnetization pitch λ is made larger essentially. Consequently, the magnetization portion is largely influenced by roundness (curvature) and unevenness of the magnetization of the magnetic drums 25, so that the outputs of the MR elements 23 and 24 shown in FIG. 3 are deviated from the sine wave and distorted. Accordingly, the calculated results of the torsional angles calculated from the MR elements 23 and 24 have large non-linearity as shown in FIG. 4. Further, the outputs of the MR elements are also changed depending on the rotational position of the magnetic drums 25 due to the influence of unevenness of the magnetization to the magnetic drums. In addition, since the magnetization pitch λ is large, the space between the MR elements 23 and 24 is also large, so that the substrate 22 in which the MR elements 23 and 24 are mounted is also large.

On the other hand, in the case of the torque sensor disclosed in JP-A-2001-324394, since the torsional angle of the torsion bar is detected magnetically, it is necessary to form partially spiral projections on the rotating body in the repeated manner.

### SUMMARY OF THE INVENTION

It is a main object of the present invention to provide a torque sensor which can increase the torque detection accuracy (detection accuracy of torsional angle) with a very simpler structure as compared with a prior art. Further, it is another object of the present invention to provide a torque sensor which can also detect the rotational position of a rotational axis in addition to the torsional angle.

In order to achieve the above objects, the present invention is constructed as follows:

(1) According to an aspect of the present invention, the torque sensor including magnetic media attached to an input axis (first axis) and an output axis (second axis) coupled through a torsion bar, respectively, and each having magnetic tracks magnetized at a predetermined pitch and magnetic detection elements disposed opposite to the magnetic media and sensitive to the magnetic tracks, whereby torque is detected on the basis of output signals of the magnetic detection elements, comprises at least two magnetic tracks for detection of torque, formed in each of the magnetic media attached to the input and output axes with a magnetic phase difference.

Preferably, in addition to the at least two magnetic tracks having the magnetic phase difference, there are provided magnetic tracks for identifying any number of periods of a magnetic pattern in the at least two magnetic tracks.

(2) According to another aspect of the present invention, the torque sensor comprises first and second axes coupled through a torsion bar, at least one or more moving coil rotated together with the first or second axis and disposed to produce electromagnetic induction by a magnetic field perpendicular to the first or second axis, and at least one or more fixed coil fixedly mounted relatively to the first or second axis and disposed to produce electromagnetic induction by a magnetic field perpendicular to the first or second axis.

Other objects, features and advantages of the invention will become apparent from the following description of the embodiments of the invention taken in conjunction with the accompanying drawings.

### BRIEF DESCRIPTION OF THE DRAWINGS

FIG. 1 is a perspective view of a torque sensor of a first embodiment according to the present invention;

FIG. 2 is a diagram explaining the principle of a conventional torque sensor of a magnetic encoder system;

FIG. 3 is a timing chart showing outputs of MR elements 23 and 24 used in FIG. 2;

FIG. 4 is a output characteristic diagram of the conventional torque sensor;

FIG. 5 is a sectional view of the torque sensor of the first embodiment according to the present invention;

FIG. 6 shows magnetic patterns of magnetic tracks 3, 4, 5 and 6 in the first embodiment according to the present invention;

FIG. 7 shows an arrangement of magnetic detection elements disposed on a substrate 16 in the first embodiment according to the present invention;

FIG. 8 shows an arrangement of magnetic detection elements disposed on a substrate 19;

FIG. 9 is a diagram showing outputs of magnetic detection elements 30, 31, 32 and 33 in the first embodiment according to the present invention;

FIG. 10 is a schematic diagram illustrating a signal processing circuit of the torque sensor of the first embodiment according to the present invention;

FIG. 11 is a schematic diagram illustrating an adjustment mechanism for a gap between magnetic tracks and magnetic detection elements in the first embodiment according to the present invention;

FIG. 12 shows magnetic patterns of magnetic tracks 3, 4, 5 and 6 in a first modification example of the first embodiment according to the present invention;

FIG. 13 is a schematic diagram illustrating a signal processing circuit for the modification example of FIG. 12;

FIG. 14 shows magnetic patterns of magnetic tracks 3, 4, 5 and 6 in a second modification example of the first embodiment according to the present invention;

FIG. 15 shows magnetic patterns of magnetic tracks 3, 4, 5 and 6 in a third modification example of the first embodiment according to the present invention;

FIG. 16 shows an arrangement of magnetic detection elements disposed on the substrate 16 in the third modification example of the first embodiment according to the present invention;

FIG. 17 is a diagram showing outputs of magnetic detection elements 30, 31, 32, 33, 66 and 67 in the third modification example of the first embodiment according to the present invention;

FIG. 18 shows magnetic patterns of the magnetic tracks 3, 4, 5 and 6 in a fourth modification example of the first embodiment according to the present invention;

FIG. 19 shows an arrangement of magnetic detection elements disposed on the substrate 16 in the fourth modification example of the first embodiment according to the present invention;

FIG. 20 is a diagram showing outputs of the magnetic detection elements 30, 31, 32 and 33 in the fourth modification example of the first embodiment according to the present invention;

FIG. 21 is a perspective view showing a torque sensor of a second embodiment according to the present invention;

FIG. 22 shows an arrangement of a moving coil 69 and fixed coils 70 and 71 of the torque sensor of the second embodiment according to the present invention;

FIG. 23 is a schematic diagram illustrating a signal processing circuit of the second embodiment according to the present invention;

FIG. 24 is a timing chart showing operation of the torque sensor of the second embodiment according to the present invention;

FIG. 25 shows outputs of the fixed coils 70 and 71 used in the second embodiment according to the present invention; and

FIG. 26 is a schematic diagram illustrating a motor-driven power steering system using the torque sensor according to the present invention.

### DESCRIPTION OF THE EMBODIMENTS

Embodiments of the present invention are now described with reference to the accompanying drawings.

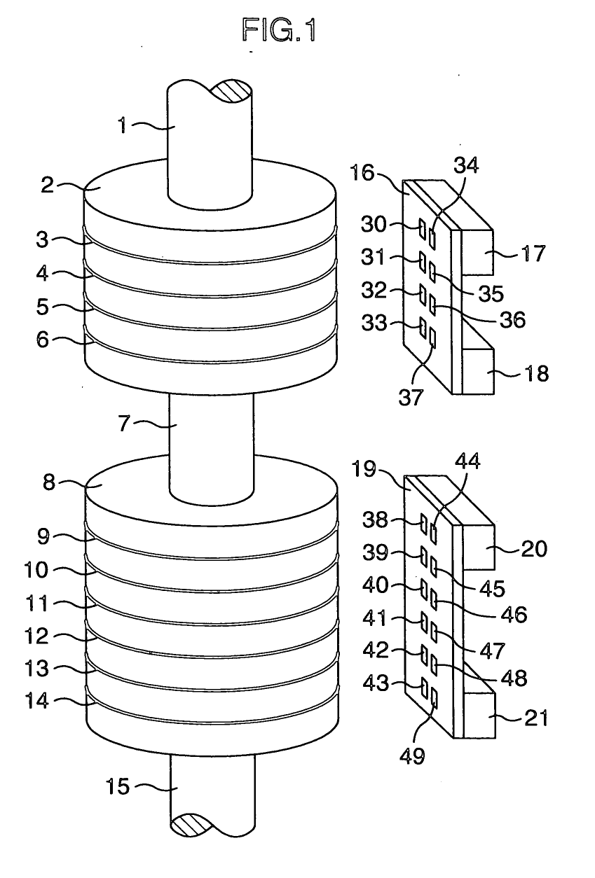

Referring first to FIGS. 1, 5, 6, 7, 8, 9, 10 and 11, a torque sensor according to a first embodiment of the present invention is described.

FIG. 1 is a perspective view of the torque sensor according to the first embodiment and FIG. 5 is a sectional view thereof. As the torque sensor of the embodiment, there is shown, by way of example, a sensor of a magnetic encoder type which detects torque exerted on a rotational axis (steering axis) of a steering wheel for a vehicle.

The rotational axis (input axis; first axis) 1 connected to the steering wheel and a rotational axis (output axis; second axis) 15 connected to wheels are connected through a torsion bar 7. The torsion bar 7 is twisted in accordance with the torque exerted on the rotational axes 1 and 15 from the steering wheel.

A cylindrical magnetic medium (magnetic drum) 2 is supported by the rotational axis 1 and is rotated together with the rotational axis 1. The surface of the magnetic drum 2 is magnetized to thereby form magnetic tracks 3, 4, 5 and 6.

A magnetic drum 8 is supported by the rotational axis 15 and is rotated together with the rotational axis 15. The surface of the magnetic drum 8 is magnetized to thereby form magnetic tracks 9, 10, 11, 12, 13 and 14.

A substrate 16 is disposed opposite to the magnetic drum 2. A plurality of magnetic detection elements 30 to 33 corresponding to the magnetic tracks 3 to 6 and magnetic write heads 34 to 37 for magnetizing to form the magnetic tracks 3 to 6 are disposed in the substrate 16 in two lines. The gap between the substrate 16 and the magnetic drum 2 can be adjusted by piezoelectric elements 17 and 18 fixedly mounted to the substrate 16.

A substrate 19 is disposed opposite to the magnetic drum 8. A plurality of magnetic detection elements 38 to 43 corresponding to the magnetic tracks 9 to 14 and magnetic write heads 44 to 49 for magnetizing to form the magnetic tracks 9 to 14 are disposed in the substrate 19 in two lines. The gap between the substrate 19 and the magnetic drum 8 can be adjusted by piezoelectric elements 20 and 21 fixedly mounted to the substrate 19.

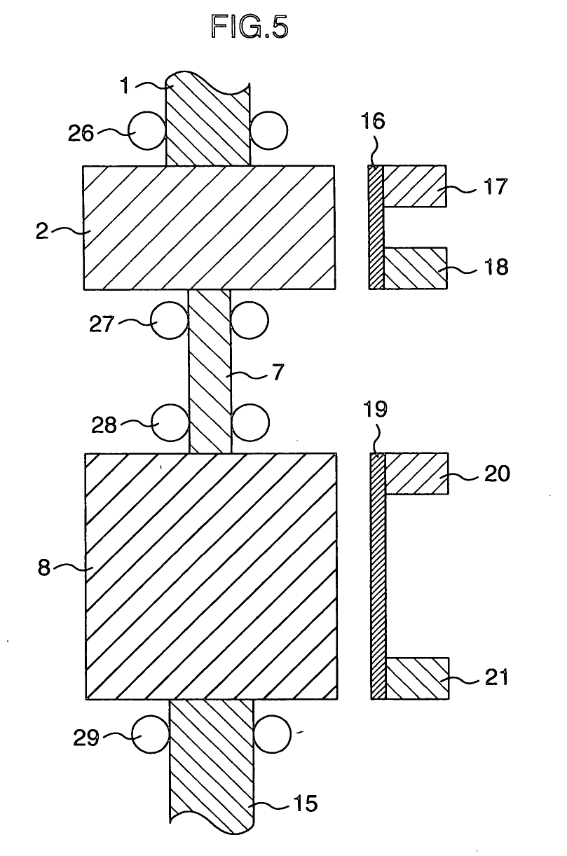

Magnetic patterns of the magnetic tracks 3, 4, 5 and 6 in the magnetic drum 2 are now described with reference to FIG. 6. The magnetic track 3 has a magnetic pattern having N (pole) and S (pole) magnetized at a magnetization pitch λ. The magnetic track 4 has a magnetic pattern having N and S magnetized at a magnetization pitch λ equal to that of the magnetic track 3 and having a phase difference of λ/4 (90 degrees) with respect to the magnetic track 3.

The magnetic track 5 has a magnetic pattern having N and S magnetized at a magnetization pitch 2λ. The magnetic track 6 has a magnetic pattern having N and S magnetized at a magnetization pitch 4λ.

Magnetic patterns of the magnetic tracks 9, 10, 11, 12, 13 and 14 in the magnetic drum 8 are not shown but are as follows:

The magnetic track 9 has the same magnetic pattern as that of the magnetic track 3. The magnetic track 10 has the same magnetic pattern as that of the magnetic track 4. The magnetic track 11 has the same magnetic pattern as that of the magnetic track 5. The magnetic track 12 has the same magnetic pattern as that of the magnetic track 6. The magnetic track 13 has a magnetic pattern having N and S magnetized alternately at a magnetization pitch 8λ. The magnetic track 14 has a magnetic pattern having N and S magnetized alternately at a magnetization pitch 16λ.

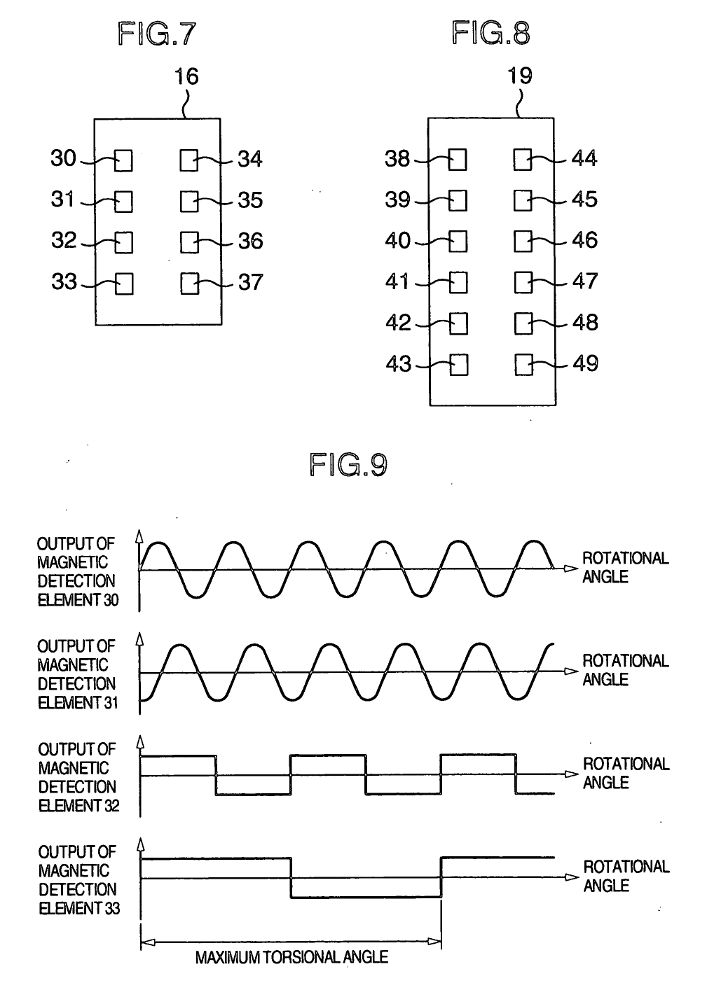

FIG. 7 shows an arrangement of the magnetic detection elements 30 to 33 and the magnetic write heads 34 to 37 disposed in the substrate 16.

The magnetic detection elements 30, 31, 32 and 33 are disposed opposite to the magnetic tracks 3, 4, 5 and 6 to detect the magnetism of the magnetic tracks 3, 4, 5 and 6. Hall elements, MR elements (magneto-resistive elements), GMR elements (giant magneto-resistive elements) and the like can be used as the magnetic detection elements 30, 31, 32 and 33.

When the magnetic detection elements of the type that has no sensitivity to the magnetic pole and produces an output changed in accordance with only the magnitude of the magnetism are used, the phases of the magnetic tracks 4 and 10 with respect to the magnetic tracks 3 and 9 is set to λ/8.

In the embodiment, the magnetic write heads 34, 35, 36 and 37 are disposed in parallel to the magnetic detection elements 30 to 33 and the magnetic tracks 3, 4, 5 and 6 are written on the magnetic drum 2 by the magnetic write heads 34, 35, 36 and 37, respectively. In this manner, the phase shift between the magnetic tracks 3, 4, 5 and 6 and the magnetic detection elements 30, 31, 32 and 33 can be eliminated.

When the magnetic write heads 34, 35, 36 and 37 and the magnetic detection elements 30, 31, 32 and 33 are mounted or disposed separately from each other, the phase shift may occur between the magnetic tracks 3, 4, 5 and 6 and the magnetic detection elements 30, 31, 32 and 33 and a detection error may occur if the magnetic write heads 34, 35, 36 and 37 are inclined right to magnetize the magnetic tracks 3, 4, 5 and 6 and the magnetic detection elements 30, 31, 32 and 33 are mounted obliquely in the left direction, for example. This problem can be solved by mounting the magnetic detection elements 30, 31, 32 and 33 and the magnetic write heads 34, 35, 36 and 37 on the same substrate. FIG. 8 shows an arrangement of the magnetic detection elements 38 to 43 and the magnetic write heads 44 to 49 disposed in the substrate 19.

The magnetic detection elements 38, 39, 40, 41, 42 and 43 are disposed opposite to the magnetic tracks 9, 10, 11, 12, 13 and 14 to detect the magnetism of the magnetic tracks 9, 10, 11, 12, 13 and 14. Similarly to the substrate 16, the magnetic write heads 44, 45, 46, 47, 48 and 49 for magnetizing the magnetic tracks 9, 10, 11, 12, 13 and 14 on the magnetic drum 8 are disposed in the substrate 19, so that the magnetic tracks 9, 10, 11, 12, 13 and 14 are written on the magnetic drum 8 by the magnetic write heads 44, 45, 46, 47, 48 and 49. In this manner, the phase shift between the magnetic tracks 9, 10, 11, 12, 13 and 14 and the magnetic detection elements 38, 39, 40, 41, 42 and 43 are eliminated. Further, the writing into the magnetic tracks 3, 4, 5 and 6 can be made simultaneously with the writing into the magnetic tracks 9, 10, 11, 12, 13 and 14, so that the arrangement of the magnetic detection elements 30, 31, 32 and 33 with respect to the magnetic tracks 3, 4, 5 and 6 can be made relatively identical with the arrangement of the magnetic detection elements 38, 39, 40, 41, 42 and 43 with respect to the magnetic tracks 9, 10, 11, 12, 13 and 14. This contributes to improvement of the detection accuracy of the torque as described later.

Referring now to FIG. 9, output signals of the magnetic detection elements 30, 31, 32 and 33 are described.

When the magnetic drum 2 is rotated, the output of the magnetic detection element 30 is changed like the sine wave as shown in FIG. 9. The output of the magnetic detection element 31 is changed like the sine wave with the phase difference of 90 degrees at an electrical angle with respect to the output of the magnetic detection element 31.

The output of the magnetic detection element 32 has the period which is twice the output of the magnetic detection element 30 and is changed like the square wave. The output square wave is obtained by increasing the writing magnetic field of the magnetic track 5 or increasing the sensitivity of the magnetic detection element 32 to the degree that the sensitivity of the magnetic detection element is saturated.

The magnetic detection element 33 has the period which is quadruple the output of the magnetic detection element 30 and its output waveform is square similarly.

On the other hand, although not shown, the magnetic detection element 38 produces the output having the same waveform as the magnetic detection element 30 in accordance with the rotation of the magnetic drum 8. The magnetic detection element 39 produces the same waveform as the magnetic detection element 31, the magnetic detection element 40 produces the same waveform as the magnetic detection element 32, the magnetic detection element 41 produces the same waveform as the magnetic detection element 33, the magnetic detection element 42 produces the square wave having the period equal to eight times of the magnetic detection element 38, and the magnetic detection element 43 produces the square wave having the period equal to 16 times of the magnetic detection element 38.

The output signals of the magnetic detection elements 32 and 33 are binary signals for identifying four periods of the output signals of the magnetic detection elements 30 and 31. More particularly, the binary signals “1, 1”, “0, 1”, “1, 0” and “0, 0” of the magnetic detection elements 32 and 33 can identify four periods of the output signals of the magnetic detection elements 30 and 31. In other words, the magnetic patterns of the magnetic tracks 5 and 6 shown in FIG. 6 are to identify four pitches (4λ) of the magnetization pitch λ of the magnetic tracks 3 and 4. Further, the output signals of the magnetic detection elements 40 and 41 are binary signals for identifying four periods of the magnetic detection elements 38 and 39. That is, the magnetic patterns of the magnetic tracks 11 and 12 are to identify four pitches (4λ) of the magnetization pitch λ of the magnetic tracks 9 and 10. The torsional angle can be calculated from a difference between a rotational angle of the magnetic drum 2 (obtained by calculating the periods of the output signals of the magnetic detection elements 30 and 31 and the arc tangent thereof) and a rotational angle of the magnetic drum 8 (obtained by calculating the periods of the output signals of the magnetic detection elements 38 and 39 and the arc tangent thereof).

As described above, the output waveforms of the magnetic detection elements 30, 31, 38 and 39 which are changed like the sine wave in accordance with the rotation of the magnetic drums 2 and 8 can be detected by four periods. That is, change of the angle in four periods can be detected and the maximum of the torsional angle can be obtained in four periods of the output signals (four magnetization pitches).

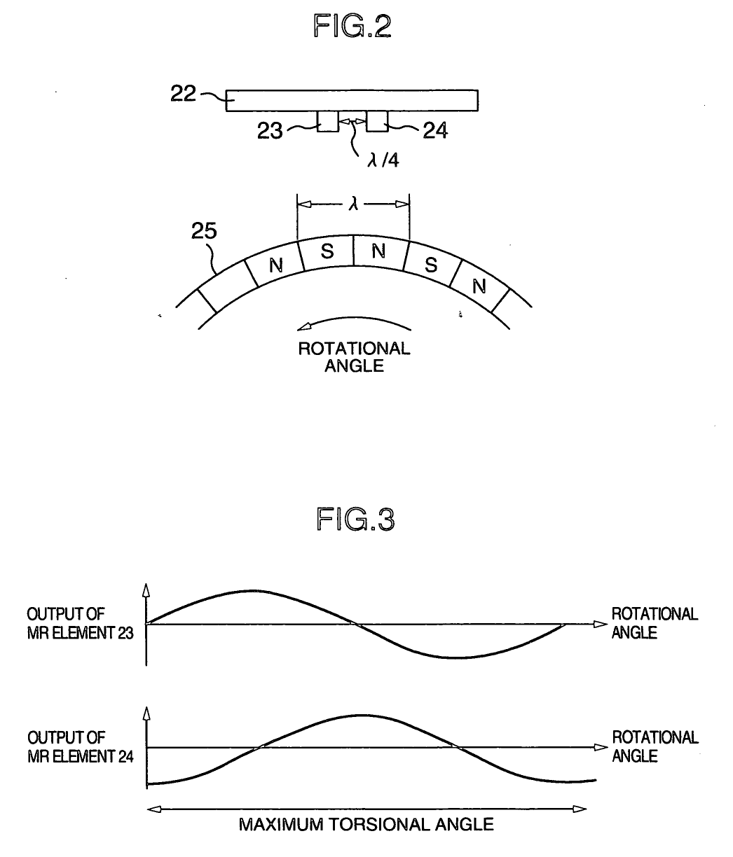

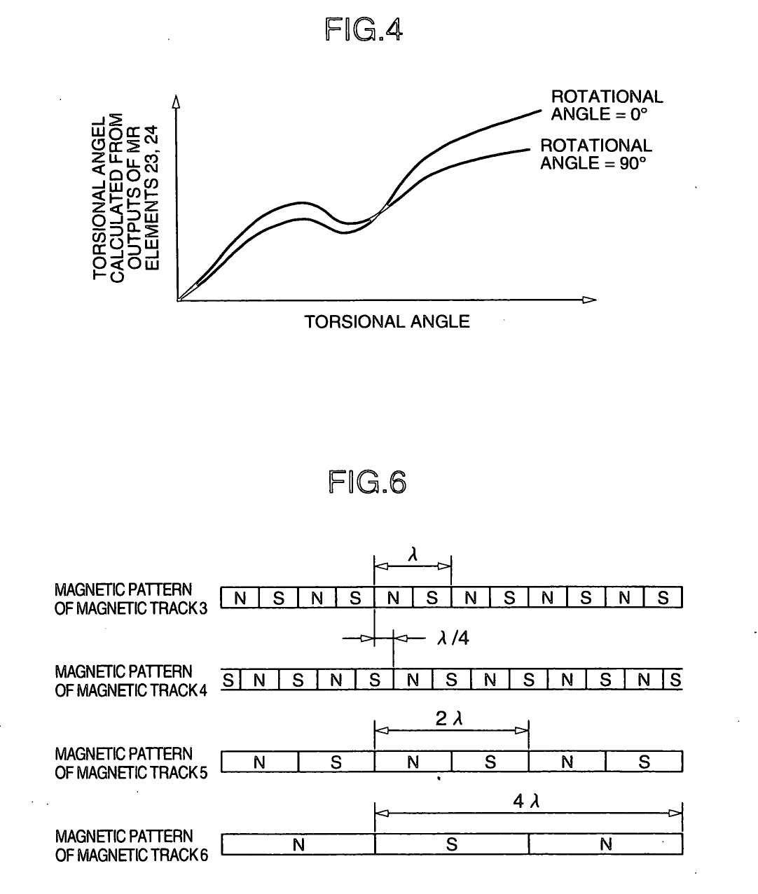

Conversely, this means that the magnetization pitch can be made to be ¼ as compared with the magnetization pitch of the magnetic track of the conventional torque sensor shown in FIG. 2. Accordingly, since the curvature for one pitch in the magnetic drum is ¼ as compared with the prior art, influence of roundness of the magnetic drum 2 to the output signal of the magnetic detection element 30 can be reduced relatively (this roundness causes deviation from the sine wave and distortion of the waveform of the magnetic detection element). In other words, the magnetization pitch can be reduced to thereby reduce deviation and distortion of the sine waveform of the output signal of the magnetic detection element 30.

Further, the system for detecting the rotational angles of the magnetic drums by the method of shifting the plurality of magnetic tracks by λ/4 is adopted instead of the method of shifting the space between the two magnetic detection elements by λ/4 of the magnetization pitch as in the prior art. Thus, since the space between the two magnetic detection elements requires λ/4 at minimum in the prior art, the size of the substrate 16 is limited by λ/4, although the embodiment is not limited by λ/4. Accordingly, the size of the substrate 16 can be made smaller than the prior art.

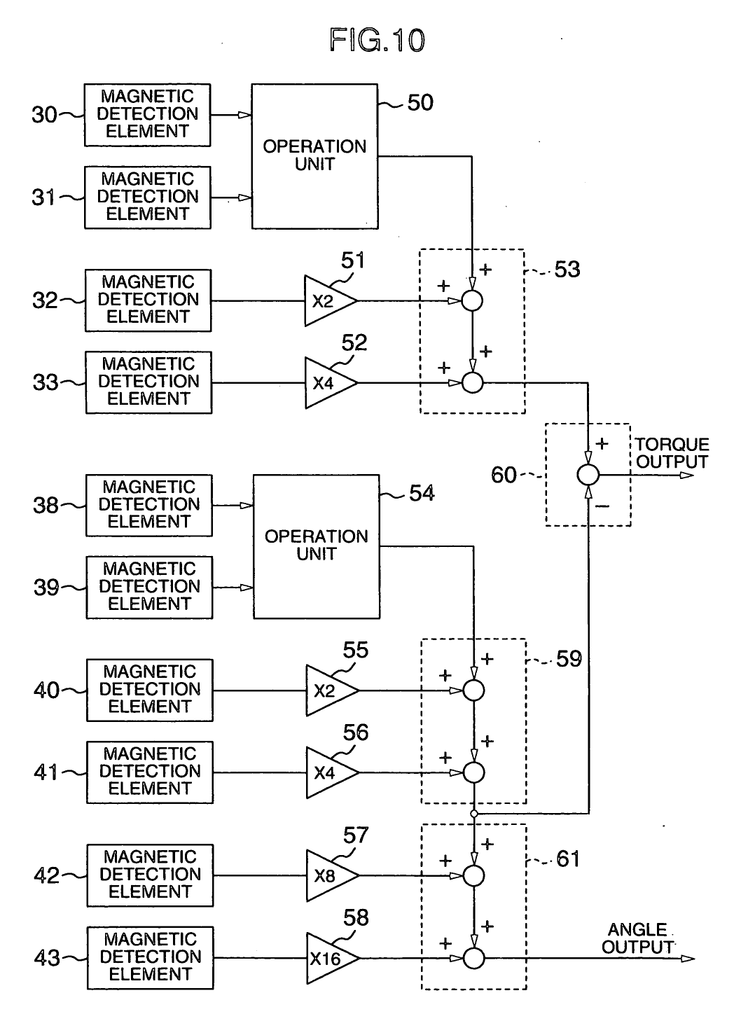

Referring now to FIG. 10, a signal processing circuit of the torque sensor according to the embodiment is described.

In the signal processing circuit, an operation unit 50 calculates the ratio of signals of the magnetic detection elements 30 and 31 and the arc tangent thereof. A multiplier 51 doubles the output of the magnetic detection element 32. A multiplier 52 quadruples the output of the magnetic detection element 33. The multipliers 51 and 52 weight the outputs of the magnetic detection elements 32 and 33.

The rotational angle of the magnetic drum 2 is obtained by calculating the sum total of the output of the operation unit 50 and the outputs of the multipliers 51 and 52 by an adder 53.

On the other hand, an operation unit 54 calculates the ratio of signals of the magnetic detection elements 38 and 39 and the arc tangent thereof. A multiplier 55 doubles the output of the magnetic detection element 40. A multiplier 56 quadruples the output of the magnetic detection element 41. The rotational angle of the magnetic drum 8 is obtained by calculating the sum total of the output of the operation unit 54 and the outputs of the multipliers 55 an 56 by an adder 59.

A subtracter 60 calculates a difference between the outputs of the adders 53 and 59 to produce a difference between the rotational angles of the magnetic drums 2 and 8, that is, the torsional angle (depending on the torque) of the torsion bar 7.

A multiplier 57 multiplies the output of the magnetic detection element 42 by 8 and a multiplier 58 multiplies the output of the magnetic detection element 43 by 16.

An adder 61 calculates the sum total of the output of the adder 59 and the outputs of the multipliers 57 and 57 to produce the rotational angle of the magnetic drum 8.

According to the above configuration, not only the torque output but also the steering angle of the steering wheel can be produced. Further, by adding the magnetic tracks disposed in the magnetic drum 8 and the magnetic detection elements opposite to the magnetic tracks, the detection range of the steering angle of the steering wheel can be easily expand to 360 degrees.

An adjustment mechanism for a gap between the magnetic drum 2 and the substrate 16 of the torque sensor of the embodiment is now described.

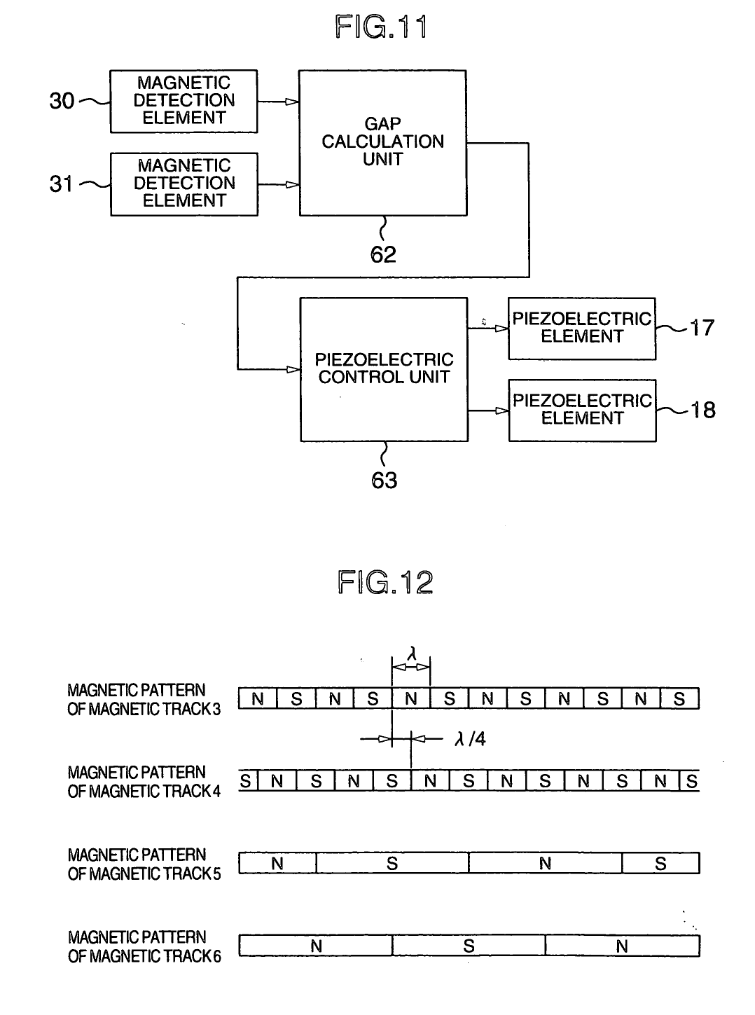

As shown in FIG. 11, the gap adjustment mechanism calculates a sum of the outputs squared of the magnetic detection elements 30 and 31 in a gap calculation unit 62 and detects the gap between the magnetic drum 2 and the substrate 16 from the sum. A piezoelectric element control unit 63 controls voltages applied to the piezoelectric elements 17 and 18 so that the detected gap value is fixed to thereby control the gap between the magnetic drum 2 and the substrate 16 to be fixed. In this manner, the gap between the magnetic drum 2 and the substrate 16 can be fixed to thereby stabilize the signals of the magnetic detection elements. Further, inclination of the substrate 16 can be controlled by controlling the piezoelectric elements 17 and 18.

An adjustment mechanism for a gap between the magnetic drum 8 and the substrate 19 is also configured in the same manner as that of FIG. 11.

In the embodiment, the substrates 16 and 19 formed separately are disposed opposite to the magnetic drums 2 and 8 in the vicinity of the magnetic drums 2 and 8, respectively. On the other hand, in the prior art, magnetic detection elements opposite to magnetic drums 2 and 8 are disposed in one substrate.

In one conventional substrate system, in order to make small the substrate, it is necessary to dispose the magnetic drums 2 and 8 in close vicinity thereto and accordingly a complicated structure is required for prevention of distortion of the torsion bar. Further, there occurs a problem that the torsion bar 7 becomes shorter and the torsion amount by the torque is reduced since the magnetic drums 2 and 8 are disposed in close vicinity thereto. Moreover, there is the limitation even if the magnetic drums 2 and 8 are disposed in close vicinity thereto and the substrate in which the magnetic detection elements are mounted becomes very large.

On the contrary, in the torque sensor of the embodiment according to the present invention, bearings 26, 27, 28 and 29 for supporting the rotational axes 1 and 15 and the torsion bar 7 can be disposed easily as shown in FIG. 5. Consequently, the torsion bar 7 can be made longer so that the torsion amount produced by the torque can be made larger easily. Further, mechanical distortion of the torsion bar 7 can be suppressed by the support structure of the bearings and variation of the gap between the magnetic drums 2 and 8 and the substrates 16 and 19 produced by the mechanical distortion can be suppressed very small.

A modification example of the torque sensor according to the first embodiment is now described.

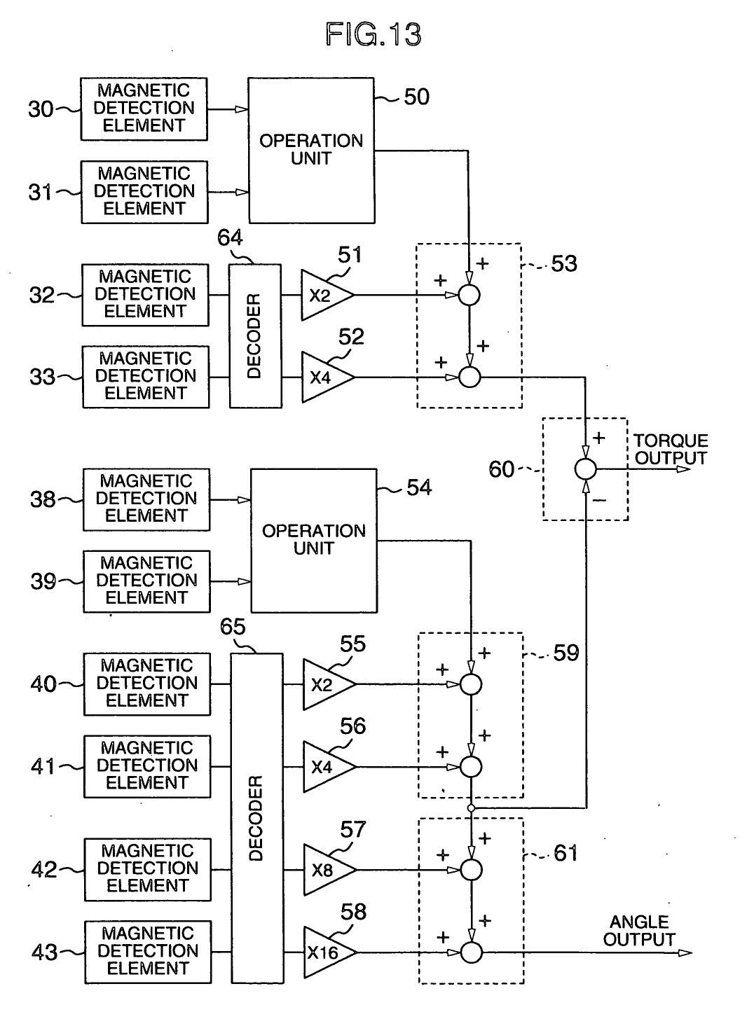

FIG. 12 shows magnetic patterns of the magnetic tracks 3, 4, 5 and 6 in the first modification example and FIG. 13 is a schematic diagram illustrating a signal processing circuit thereof.

In this example, as shown in FIG. 12, the magnetization patterns of the magnetic tracks 3 and 4 are the same as the torque sensor of the aforementioned embodiment, while with regard to the magnetic tracks 5 and 6 the gray code is adopted to thereby eliminate the influence of the hazard.

Accordingly, the signal processing circuit shown in FIG. 13 includes a decoder 64 for converting the gray code into the binary code. Further, similarly, with regard to the magnetic tracks 11, 12, 13 and 14 the gray code is adopted as a countermeasure against the hazard and the signal processing circuit includes a decoder 65 for converting the gray code into the binary code.

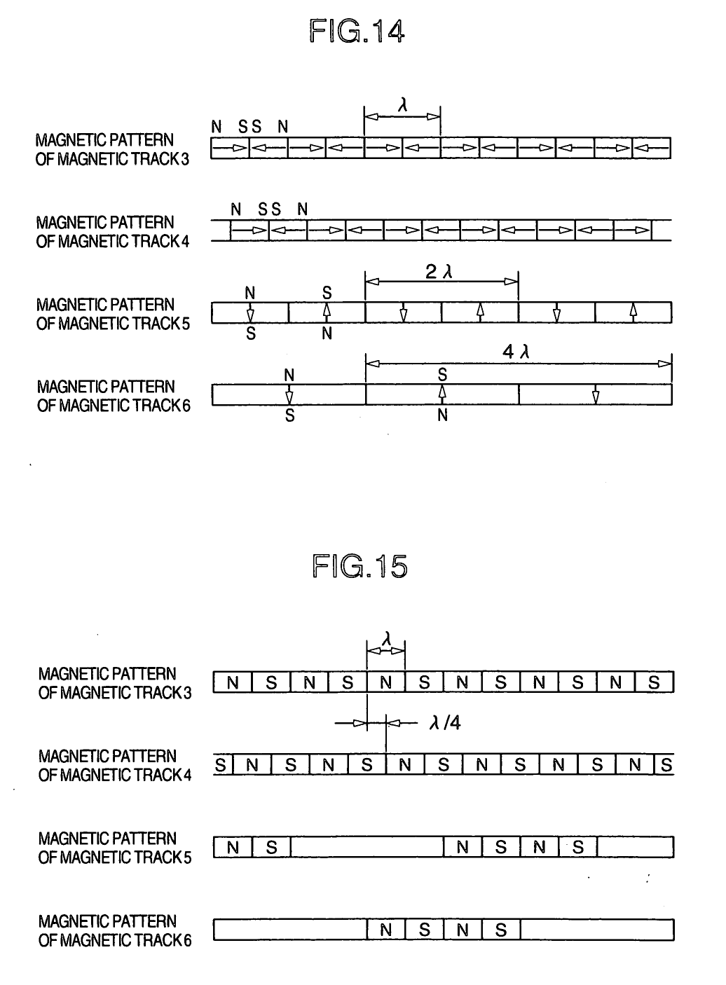

A second modification example of the first embodiment is now described with reference to FIG. 14.

FIG. 14 shows magnetic patterns of the magnetic tracks 3, 4, 5 and 6 of the second modification example.

In this example, magnetic tracks having the magnetization directions different from each other between the adjacent tracks are formed in two or more magnetic tracks formed in the magnetic drums 2 and 8. The magnetic detection elements corresponding to the magnetic tracks use magnetic detection elements sensitive to the particular magnetization direction.

More particularly, magnetization portions having the magnetization directions reversed to each other in the horizontal direction in the adjacent magnetization portions are formed on the magnetic track 3 repeatedly and alternately. The magnetic track 4 has the magnetic pattern which is identical with the magnetic track 3 but is shifted by the phase of λ/4 of the magnetization pitch λ with respect to the magnetic track 3. The magnetic track 5 is magnetized in the vertical direction to the magnetic tracks 3 and 4 and the magnetization pitch thereof is 2λ. The magnetic track 6 is magnetized in the vertical direction to the magnetic tracks 3 and 4 and the magnetization pitch thereof is 4λ. Further, in the embodiment, magnetic detection elements such as MR elements having the anisotropy are used as the magnetic detection elements 30 and 31 and the MR elements are disposed in the direction in which the MR elements react to the magnetism in the magnetization direction magnetized in the magnetic track 3. Moreover, magnetic detection elements such as MR elements having the anisotropy are also used as the magnetic detection elements 32 and 33 and the MR elements are disposed in the direction in which the MR elements react to the magnetism in the magnetization direction magnetized in the magnetic track 5. Thus, the influence of the magnetic force of the magnetic tracks 5 and 6 to the magnetic detection elements 32 and 33 is minimized. This is achieved by shifting the direction of detecting the magnetism of the magnetic direction elements 32 and 33 and the direction of magnetizing the magnetic tracks 5 and 6 by 90 degrees.

A third modification example of the first embodiment is now described with reference to FIGS. 15, 16 and 17.

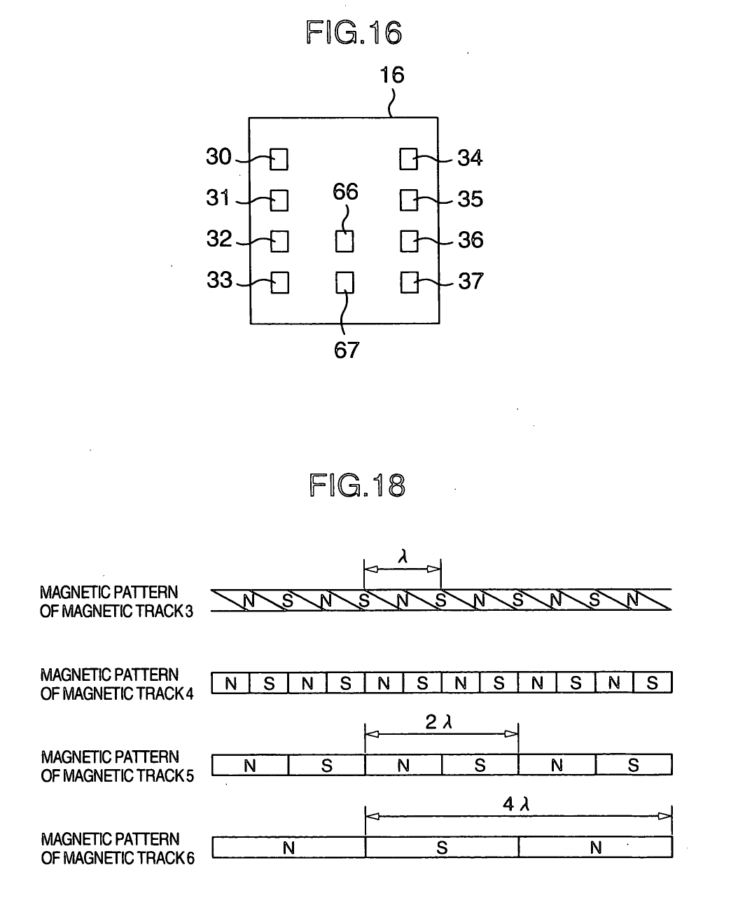

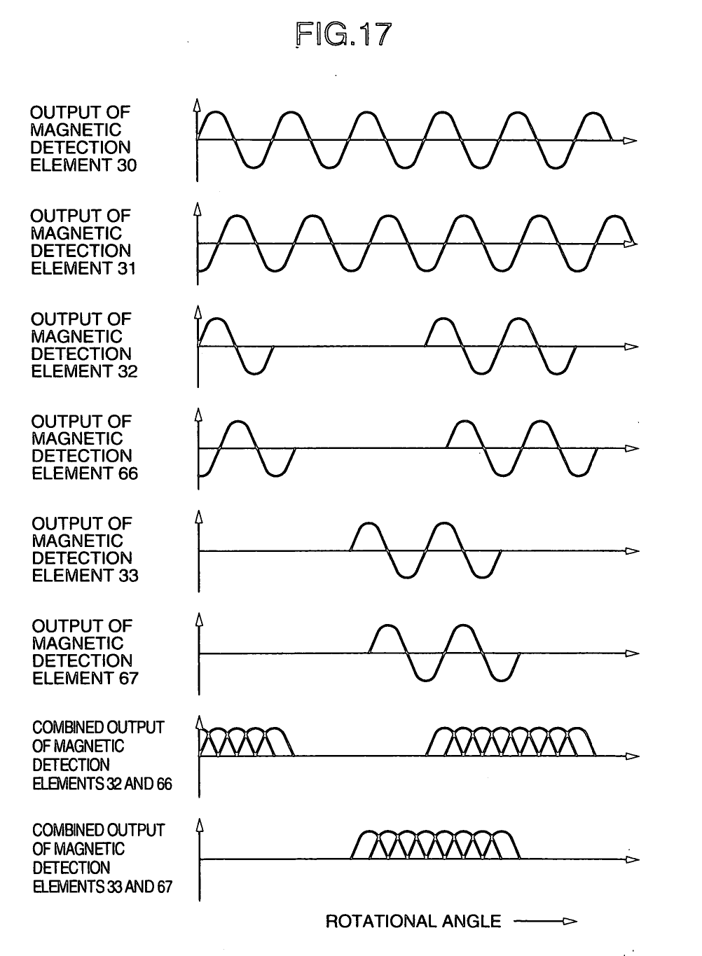

FIG. 15 shows magnetic patterns of the magnetic tracks 3, 4, 5 and 6 according to this example, FIG. 16 shows an arrangement of the magnetic detection elements disposed in the substrate 16 in this example, and FIG. 17 shows outputs of the magnetic detection elements 30, 31, 32, 33, 66 and 67 according to this example.

The magnetic tracks 3 and 4 of this example are the same as the torque sensor of the first embodiment as shown in FIG. 15. In the magnetization pattern of the magnetic tracks 5 and 6, the gray code is adopted and the magnetization is made so that the state “1” is magnetized by the polarity of N-S and the state “0” is not magnetized.

By constructing as above, the higher-rank code can be formed even in the magnetic detection elements which react with high sensitivity to the magnetic field in the parallel direction to the substrate 16 as the MR elements.

The magnetic tracks 5 and 6 are magnetized by the magnetization pattern of “N-S-N-S” at intervals of 720 degrees at the electrical angle intermittently and the phase difference of the magnetization between the magnetic tracks 5 and 6 is 360 degrees.

As shown in FIG. 16, the magnetic detection elements 30, 31, 32 and 33 and the magnetic write heads 34, 35, 36 and 37 are disposed in the substrate 16 in the same manner as the first embodiment. Further, magnetic detection elements 66 and 67 are disposed in the substrate 16. The magnetic detection element 66 is disposed while being shifted or moved by 90 degrees at the electrical angle with respect to the magnetic detection element 32. The magnetic detection element 67 is also disposed while being shifted or moved by 90 degrees at the electrical angle with respect to the magnetic detection element 33.

As shown in FIG. 17, the outputs of the magnetic detection elements 30 and 31 are the same as the first embodiment.

The magnetic detection element 32 produces an alternating signal in portions where the magnetic track 5 is magnetized and the output of the element 32 is zero in portions where the track 5 is not magnetized. The output of the magnetic detection element 66 is shifted by 90 degrees at the electrical angle in phase with respect to the output of the magnetic detection element 32.

The signal processing unit calculates a sum of a full-wave-rectified signal of the output of the magnetic detection element 32 and a full-wave-rectified signal of the output of the magnetic detection element 66 to thereby obtain a combined output as shown in FIG. 17.

The magnetic detection element 33 produces an alternating signal in portions where the magnetic track 6 is magnetized in the same manner as the magnetic detection element 32 and the output of the element 33 is zero in portions where the track 6 is not magnetized. The output of the magnetic detection element 67 is shifted by 90 degrees at the electrical angle in phase with respect to the output of the magnetic detection element 33. The signal processing unit calculates a sum of a full-wave-rectified signal of the output of the magnetic detection element 33 and a full-wave-rectified signal of the output of the magnetic detection element 67 to thereby obtain a combined output as shown in FIG. 17.

In this example, the combined output of the magnetic detection elements 32 and 66 and the combined output of the magnetic detection elements 33 and 67 can be used to recognize the signals in four periods (4λ) of the magnetic detection element 30. In other words, the maximum of the torsional angle can be indicated by 4λ in the same manner as the aforementioned embodiment to increase the torque detection accuracy.

A fourth modification example of the first embodiment is now described with reference to FIGS. 18, 19 and 20.

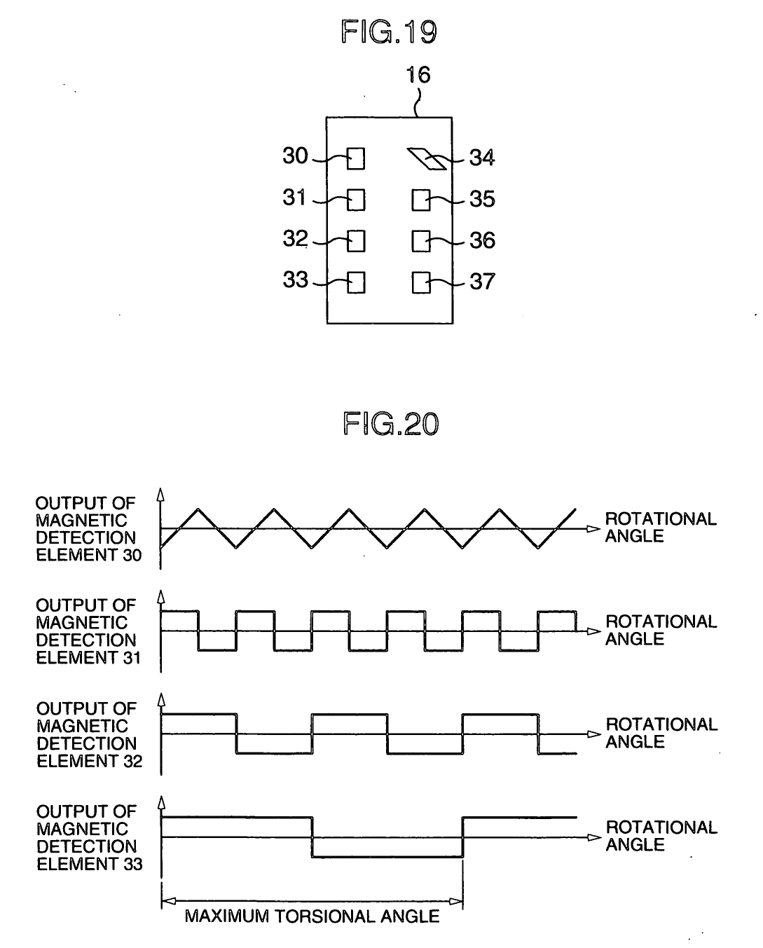

FIG. 18 shows magnetic patterns of the magnetic tracks 3, 4, 5 and 6 according to this embodiment, FIG. 19 shows an arrangement of magnetic detection elements disposed in the substrate 16 in this example, and FIG. 20 shows outputs of the magnetic detection elements 30, 31, 32 and 33 according to this example.

In this example, the magnetic track 3 is magnetized obliquely as shown in FIG. 18. In this case, in order to magnetize the track 3 obliquely, the magnetic write head 3 is disposed obliquely as shown in FIG. 19. The magnetization pitch of the magnetic tracks 3 and 4 is λ, the magnetization pitch of the magnetic track 5 is 2λ and the magnetization pitch of the magnetic track 6 is 4λ.

The output of the magnetic detection element 30 is changed like the triangular wave as shown in FIG. 20. Further, the magnetic detection elements 31, 32 and 33 produce a code representing the number of periods of the triangular wave of the magnetic detection element. By producing the triangular wave in this manner, the angle can be calculated easily as compared with the case where the sine wave is produced as in the first embodiment.

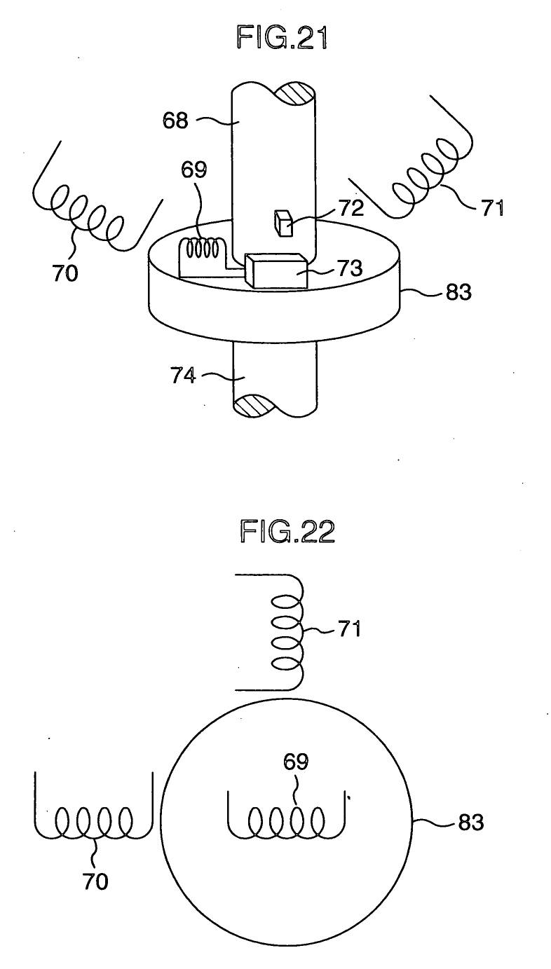

A torque sensor according to a second embodiment of the present invention is now described with reference to FIGS. 21, 22, 23, 24 and 25.

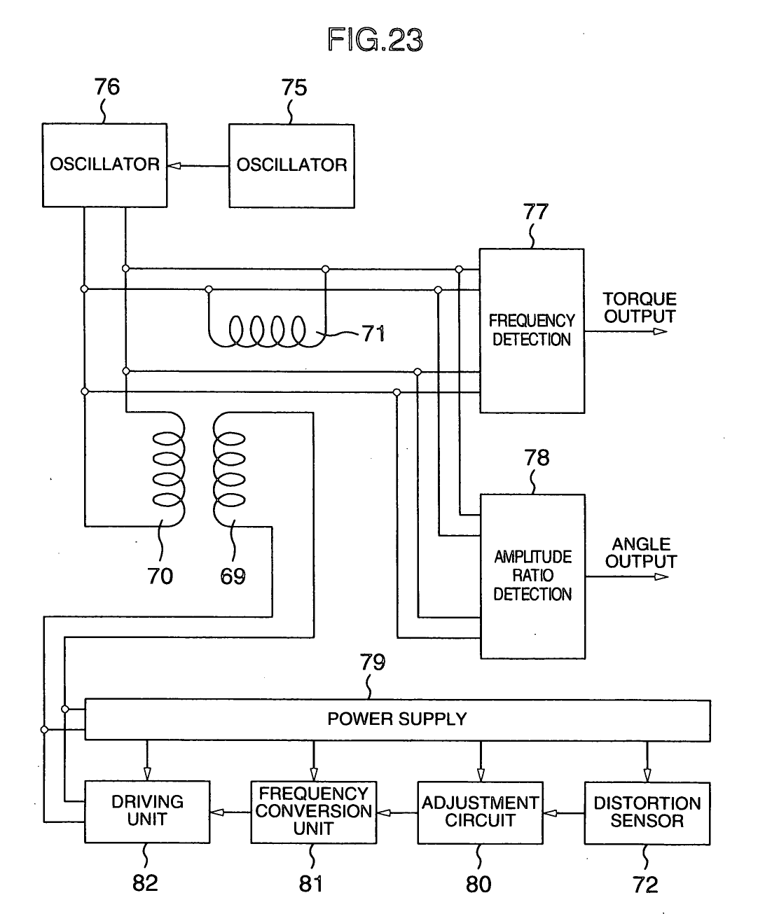

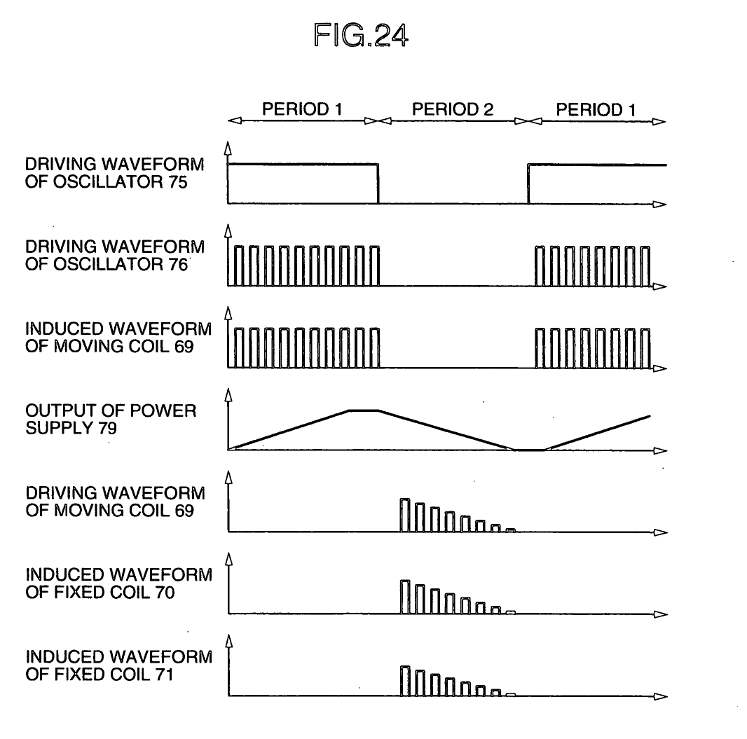

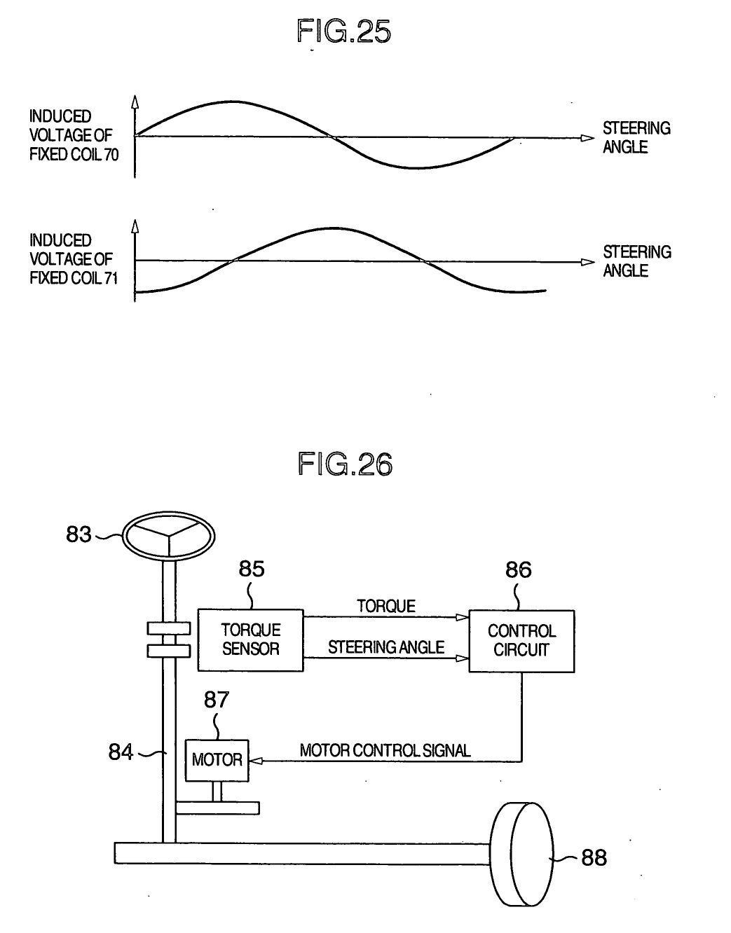

FIG. 21 is a perspective view showing the torque sensor according to the second embodiment, FIG. 22 shows an arrangement illustrating a positional relation of a moving coil 69 and fixed coils 70 and 71 used in the torque sensor, FIG. 23 is a schematic diagram illustrating a signal processing circuit of the torque sensor according to the embodiment, FIG. 24 is a timing chart thereof and FIG. 25 shows outputs of the fixed coils 70 and 71.

In the embodiment, basically, the rotational angles of the rotational axes are detected by the electromagnetic induction operation and the torque is detected by a distortion sensor provided in the rotational axis. Further, the distortion sensor is driven by utilizing electric power produced by the electromagnetic induction operation.

As shown in FIG. 21, a rotational axis 68 is connected to the steering wheel and a rotational axis 74 is connected to the wheels. The rotational axes 68 and 74 are connected through a rotational plate 83. The fixed coils 70 and 71 are disposed in the vicinity of the rotational plate 83 with the space of 90 degrees therebetween. A container 73 in which the moving coil 69 rotating together with the rotational axes 68 and 74 and the signal processing circuit are contained is disposed in the rotational plate 83.

A distortion sensor 72 is provided in the rotational axis 68 and mechanical distortion produced by the torque of the rotational axis 68 is detected by the distortion sensor 72.

The positional relation of the fixed coils 70 and 71 and the moving coil 69 is as shown in FIG. 22 as the rotational axis is viewed from above, and the fixed coils 70 and 71 are disposed at right angles to each other.

The signal processing circuit of the embodiment is now described with reference to FIG. 23.

In FIG. 23, an oscillator 75 produces a signal for deciding an operation mode (a repetition mode of periods 1 and 2 shown in FIG. 24). An oscillator 76 produces a signal for driving the fixed coils 70 and 71 during the period 1 and for turning off them during the period 2. Further, induced voltages are produced in the fixed coils 70 and 71 by the signal applied to the moving coil 69 through a driving unit 82 during the period 2 and the induced signals are supplied to a frequency detection circuit 77 and an amplitude ratio detection circuit 78.

An output of the distortion sensor 72 is adjusted in a zero point and span by an adjustment circuit 80 and then the output of the adjustment circuit 80 is converted into a frequency in accordance with the output of the distortion sensor by a frequency conversion unit 81. The frequency signal (distortion detection signal) is supplied to the moving coil 69 through the driving unit 82. A power supply circuit 79 utilizes as an energy source thereof the induced voltage of the moving coil 69 obtained during the period 1 (this will be described later).

The power supply circuit 79 supplies electric power to the distortion sensor 72, the adjustment circuit 80, the frequency conversion unit 81 and the driving unit 82. The power supply circuit 79, the adjustment circuit 80, the frequency conversion unit 81 and the driving unit 82 are contained in the container 73.

Operation of the torque senior of the embodiment is now described with reference to the timing chart of FIG. 24.

The torque sensor is operated while repeating the periods 1 and 2. Selection of the periods 1 and 2 is made by the output signal of the oscillator 75.

First, in the period 1, the fixed coils 70 and 71 are driven by the output signal of the oscillator 76, so that the moving coil 69 produces a voltage by the electromagnetic induction from the fixed coils 70 and 71. Further, since the fixed coils 70 and 71 are disposed in the orthogonal direction to each other, an stable voltage can be induced in the moving coil 69 even if the rotational axis 68 is rotated anyway.

The voltage induced in the moving coil 69 is rectified in the power supply circuit 79 to charge it and the power supply circuit 79 supplies electric power to the distortion sensor 72, the adjustment circuit 80, the frequency conversion unit 81 and the driving unit 82 in order to operate them.

The torque exerted on the rotational axis 68 is detected by the distortion sensor 72. The detected signal thereof is adjusted in the zero point and span by the adjustment circuit 80 and is converted into a frequency signal by the frequency conversion unit 81. The driving unit 82 waits until the induced voltage of the moving coil 69 disappears and thereafter drives the moving coil 69 in accordance with the output frequency of the frequency conversion unit 81.

Accordingly, the driving unit 82 waits until operation of the torque sensor moves to the period 2 and the drive signals for the fixed coils 70 and 71 are stopped, and thereafter the driving unit 82 drives the moving coil 69. When the moving coil 69 is driven, induced voltages are produced in the fixed coils 70 and 71 by the electromagnetic induction. The frequency of this signal is identical with that of the signal which drives the moving coil 69. That is, it is the signal corresponding to the signal of the distortion sensor 72. Accordingly, the frequencies of the induced voltages of the fixed coils 70 and 71 can be detected by the frequency detection circuit 77 to thereby produce the signal corresponding to the torque. Further, since the fixed coils 70 and 71 are orthogonal to each other, the induced voltages of the fixed coils 70 and 71 are changed like the sine wave in accordance with the steering angle as shown in FIG. 25 and have a phase difference of 90 degrees with respect to the steering angle. Accordingly, a ratio of amplitudes of the induced voltages of the fixed coils 70 and 71 can be detected by the amplitude ratio detection circuit 78 to thereby produce an output corresponding to the steering angle.

Structure of a motor-driven power steering system using the torque sensor of the present invention is now described with reference to FIG. 26. FIG. 26 is a schematic diagram illustrating the motor-driven power steering system using the torque sensor according to the present invention.

The motor-driven power steering system includes a steering wheel 83, a rotational axis (steering axis) 84 for transmitting rotation of the steering wheel, the torque sensor 85 of the present invention, a motor 87 for assisting rotation of the rotational axis 84, a control circuit 86 which produces a signal for controlling the motor 87 in accordance with torque and steering angle signal from the torque sensor 85, and a wheel 88.

In the motor-driven power steering system, since the torque sensor 85 of the present invention is used, the torque and the steering angle can be detected in the contactless manner and accordingly there can be constructed the motor-driven power steering system with high reliability and without loss due to contact friction.

According to the present invention, since stationary torque such as steering torque of the steering wheel can be detected with high accuracy in the contactless manner, there can be provided the torque sensor with high accuracy and high reliability.

It should be further understood by those skilled in the art that although the foregoing description has been made on embodiments of the invention, the invention is not limited thereto and various changes and modifications may be made without departing from the spirit of the invention and the scope of the appended claims.

What is claimed is:

1. A motor-driven power steering apparatus which transmits rotation of a steering wheel to wheels through a rotational axis and detects at least torque of said rotational axis so that a motor for assisting operation of the steering wheel is controlled on the basis of the detected signal, wherein
said detection of said torque is performed by providing a plurality of magnetic tracks each having a phase difference in a plurality of magnetic drums provided in two rotational axes coupled through a torsion bar and by means of a contactless magnetic encoder system.

2. A motor-driven power steering apparatus which transmits rotation of a steering wheel to wheels through a rotational axis and detects at least torque of said rotational axis so that a motor for assisting operation of the steering wheel is controlled on the basis of the detected signal, wherein
said detection of said torque is performed by detecting distortion of said rotational axis and taking out the detected signal by means of electromagnetic induction from a moving coil provided in said rotational axis to at least two fixed coils disposed around said rotational axis.
